(19) United States
(12) Patent Application Publication
(10) Pub. No.: US 2024/0076162 A1
(43) Pub. Date: Mar. 7, 2024

(54) MAINTENANCE OF A CONVEYOR SYSTEM

(71) Applicant: KONE CORPORATION, Helsinki (FI)

(72) Inventors: Mika Belov, Helsinki (FI); Mikko Piironen, Helsinki (FI)

(73) Assignee: KONE CORPORATION, Helsinki (FI)

(21) Appl. No.: 18/385,735

(22) Filed: Oct. 31, 2023

Related U.S. Application Data
(63) Continuation of application No. PCT/EP2021/064764, filed on Jun. 2, 2021.

(51) Int. Cl. B66B 5/00; B66B 25/00

(52) U.S. Cl. CPC B66B 5/0093; B66B 25/003

(57) ABSTRACT

The invention relates to an apparatus (210, 120) for managing a maintenance of a conveyor system (110), the apparatus (210, 120) configured to: receive (410) data indicative of an access right to perform the maintenance; generate (430), in response to a detection (420) of an access right to perform the maintenance, a first control signal to disable communicatively reaching the sub-system (225); generate (450), in response to a receipt (440) of an acknowledgement signal indicative of a predefined state of the maintenance, a second control signal to enable the interface (215, 260) to communicatively reach the sub-system (225). The invention also relates to a method, a computer program, and a conveyor system.

### TECHNICAL FIELD

The invention concerns in general the technical field of conveyor systems. More particularly, the invention concerns maintenance operations in relation to the conveyor systems.

### BACKGROUND

Modern conveyor systems, such as elevators, escalators, and moving walkways, are complex technical solutions having a plurality of sub-systems and devices inside. The conveyor systems may, in addition to core solutions, integrate some third party solutions, such as advertisement systems in elevators, which may be maintained and operated by third parties e.g. through sub-systems of the conveyor system in question. For accessing the sub-systems and solutions of the conveyor system there may be implemented so-called application programming interface (API), The application programming interface may be considered as a computing interface that defines interactions between multiple software applications or mixed hardware-software intermediaries. In other words, it may define signaling-related aspects between communicating entities so as to allow e.g. a maintenance of the sub-systems of the conveyor system remotely, or with external terminal devices, where applicable.

The sub-systems of the conveyor system may be divided to safety-critical systems and non-critical systems. The safety-critical systems are managed by the manufacturer of the conveyor system by definition but some of the non-critical systems may be accessed by third-parties as mentioned above if not managed and controlled by the manufacturer of the conveyor system. In any case, the safety-critical systems and applications are such that they are required to be executed all the time the conveyor system is operating. Hence, if such a safety-critical system drops out from service, or gets broken, the operation of the whole conveyor system is prevented. This is not necessarily the case with the non-critical sub-systems and applications because they are not required to be operable even if the conveyor system is in service.

Due to the complexity of the conveyor systems there is a need to introduce solutions for performing maintenance tasks digitally over the application programming interfaces, or any other interfaces, so as to allow maintaining the conveyor system optimally.

### SUMMARY

The following presents a simplified summary in order to provide basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

An object of the invention is to present an apparatus, a method, a computer program, and a conveyor system for managing a maintenance of a conveyor system.

The objects of the invention are reached by an apparatus, a method, a computer program, and a conveyor system as defined by the respective independent claims.

According to a first aspect, an apparatus for managing a maintenance of a conveyor system is provided, the apparatus configured to: receive data indicative of an access right to perform the maintenance of a sub-system of the conveyor system; generate, in response to a detection of an access right to perform the maintenance of the sub-system, a first control signal to disable communicatively reaching the sub-system; generate, in response to a receipt of an acknowledgement signal indicative of a predefined state of the maintenance, a second control signal to enable communicatively reaching the sub-system.

The apparatus may further be configured to: receive, prior to the receipt of data indicative of the access right to perform the maintenance of the sub-system of the conveyor system, a request to perform a maintenance of the conveyor system. For example, the apparatus may be configured to generate a request to provide data indicative of the access right to perform the maintenance.

Further, the apparatus may be configured to determine the sub-system subject to the maintenance from one of: the request to perform a maintenance of the conveyor system; the data indicative of the access right.

The apparatus may be configured to determine the maintenance task of the sub-system from one of: the request to perform a maintenance of the conveyor system; the data indicative of the access right.

The apparatus may advantageously be configured to generate the first control signal to disable communicatively reaching the sub-system by one of: generating the control signal to a respective interface to disable the respective interface; generating the control signal to data center to request disabling of the interface; generating the control signal to disable a service executed by the sub-system; generating the control signal to disable a sub-system level operation.

The first control signal may comprise data providing at least one definition in relation to the disabling communicatively reaching the sub-system. For example, the at least one definition may define at least an estimation of a duration of the disabling.

The apparatus may further be configured to generate a signal to data center, the signal comprising data providing at least one definition in relation to the maintenance.

The apparatus may also be configured to generate the acknowledgement signal in response to a receipt of data indicative of an access right to perform the maintenance of the sub-system of the conveyor system.

Still further, the apparatus may be configured to generate a third control signal to cause an execution of a testing procedure with respect to the sub-system of the conveyor system subject to the maintenance.

According to a second aspect, a method for managing a maintenance of a conveyor system is provided, the method, performed by an apparatus, comprises: receiving data indicative of an access right to perform the maintenance of a sub-system of the conveyor system; generating, in response to a detection of an access right to perform the maintenance of the sub-system, a first control signal to disable communicatively reaching the sub-system; generating, in response to a receipt of an acknowledgement signal indicative of a predefined state of the maintenance, a second control signal to enable communicatively reaching the sub-system.

The method may further comprise: receiving, prior to the receipt of data indicative of the access right to perform the maintenance of the sub-system of the conveyor system, a request to perform a maintenance of the conveyor system. For example, a request to provide data indicative of the access right to perform the maintenance may be generated.

The sub-system subject to the maintenance may be determined from one of: the request to perform a maintenance of the conveyor system; the data indicative of the access right.

The maintenance task of the sub-system may be determined from one of: the request to perform a maintenance of the conveyor system; the data indicative of the access right.

The first control signal to disable communicatively reaching the sub-system may be generated by one of: generating the control signal to a respective interface to disable the respective interface; generating the control signal to data center to request disabling of the interface; generating the control signal to disable a service executed by the sub-system; generating the control signal to disable a sub-system level operation.

The first control signal may comprise data providing at least one definition in relation to the disabling communicatively reaching the sub-system. For example, the at least one definition may define at least an estimation of a duration of the disabling.

The method may further comprise: generating a signal to data center, the signal comprising data providing at least one definition in relation to the maintenance.

The acknowledgement signal may also be generated in response to a receipt of data indicative of an access right to perform the maintenance of the sub-system of the conveyor system.

Still further, the method may further comprise: generating a third control signal to cause an execution of a testing procedure with respect to the sub-system of the conveyor system subject to the maintenance.

According to a third aspect, a computer program is provided, the computer program comprising computer readable program code configured to cause performing of the method according to the second aspect as defined above when said program code is run on one or more computing apparatuses.

According to a fourth aspect, a conveyor system is provided, the conveyor system comprising the apparatus according to the first aspect as defined above.

The expression “a number of” refers herein to any positive integer starting from one, e.g. to one, two, or three.

The expression “a plurality of” refers herein to any positive integer starting from two, e.g. to two, three, or four.

Various exemplifying and non-limiting embodiments of the invention both as to constructions and to methods of operation, together with additional objects and advantages thereof, will be best understood from the following description of specific exemplifying and non-limiting embodiments when read in connection with the accompanying drawings.

The verbs “to comprise” and “to include” are used in this document as open limitations that neither exclude nor require the existence of unrecited features. The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF FIGURES

The embodiments of the invention are illustrated by way of example, and not by way of limitation, in the figures of the accompanying drawings.

FIG. 1 illustrates schematically an environment for the present invention according to an example.

FIG. 2 illustrates schematically a system according to an example.

FIG. 3 illustrates schematically an apparatus according to an example.

FIG. 4 illustrates schematically a method according to an example.

### DESCRIPTION OF THE EXEMPLIFYING EMBODIMENTS

The specific examples provided in the description given below should not be construed as limiting the scope and/or the applicability of the appended claims. Lists and groups of examples provided in the description given below are not exhaustive unless otherwise explicitly stated.

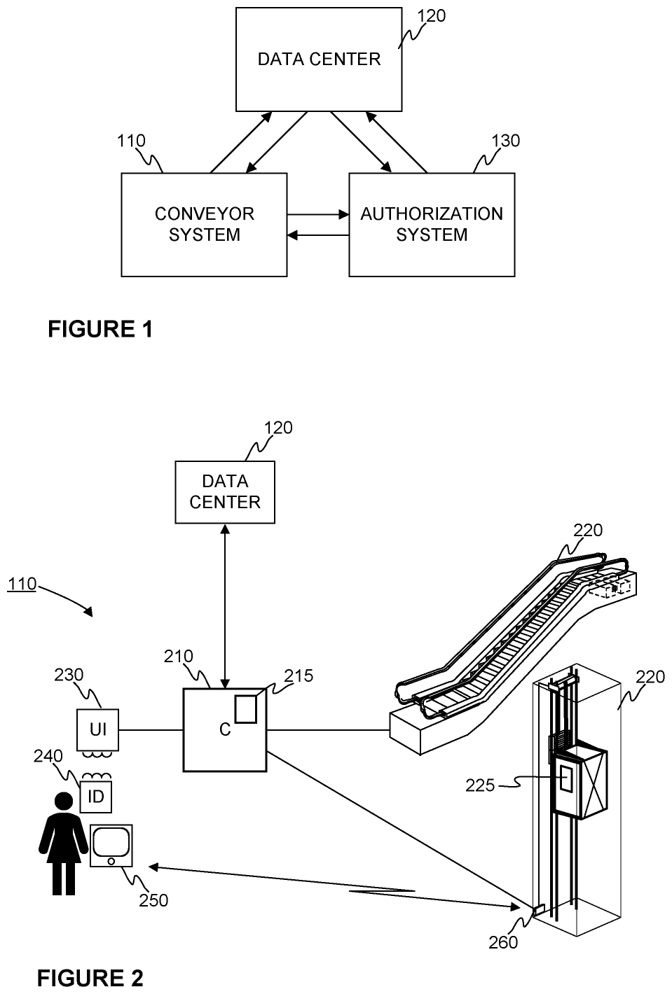

FIG. 1 illustrates schematically an environment the present invention for managing a maintenance of a conveyor system 110 may be implemented to. The conveyor system 110 may be an elevator, an escalator, or a moving walkway. The conveyor system 110 may be communicatively connected to a data center 120 which may be considered as a remote entity to the conveyor system 110 from which the conveyor system 110 may be monitored and controlled to at least to some extent. The data center 120 may e.g. refer to a remotely located premises in which a human operator may monitor an operation of one or more conveyor systems through a computer environment communicatively connected to the respective conveyor systems 110. Alternatively or in addition, the computer environment implemented with one or more computing devices and appropriate communication connections may be arranged automatically receive and transmit data from and to the respective conveyor systems 110 in order to perform its operation with respect to the conveyor systems 110. Moreover, the environment may comprise an authorization system 130 which refers to an implementation at least for managing an access to perform maintenance operations to the conveyor system 110. The authorization system 130 may be considered as a computer environment at least configured to manage access rights to the conveyor system 110 to perform maintenance operations to the conveyor system 110. The authorization system 130 may be implemented with necessary hardware and software and it may comprise input devices, such as readers, e.g. arranged in a location of the conveyor system 110 as well as one or more computing devices, such as computers, arranged to communicate with the input devices as well as the conveyor system 110, but possibly also with the data center 120. The computing device of the authorization system 130 may be arranged to operate at the location of the conveyor system 110, or remote to that. In accordance with at least some embodiments the authorization system 130 may be integrated to the conveyor system 110 so that the input devices may be devices of the conveyor system 110, such as applicable user interfaces, whereas a determination of an access right may be determined by the data center 120, if not in the conveyor system 110 itself. This kind of approach may be done by arranging a software to be executed by a computing entity of the conveyor system 110, or by a computing entity of the data center 120, causing a respective operation for evaluating if a person is authorized to access the conveyor system 110 to perform a maintenance task thereto. The evaluation may be performed e.g. on a basis of data received e.g. from input devices. It is worthwhile to emphasize that the authorization function may be internal operation of the conveyor system 110 even if it is schematically illustrated as a separate system in FIG. 1. The authorization function may, hence, be executed by a computing entity of the conveyor system 110, such as a controller therein, and configured to execute request-response method to external entities, such as to the data center 129, or any other entities.

Further aspects of the present invention are now described by referring to FIG. 2 schematically illustrating another scenario of a system the invention is implementable to. In the scenario the functionality of the authorization system 130 of FIG. 1 is integrated in the conveyor system 110 in a manner as described in the forthcoming description. The conveyor system 110 may comprise a controller which may be configured to generate control signals to conveyor devices 220 which may e.g. be one or more elevators, escalators, or moving walkways. The controller 210 may also receive data from the conveyor devices 220 and/or from their sub-systems 225. Still further, the controller 210 may be communicatively connected to one or more input devices 230, such as user interfaces through which it is possible to provide service calls to the respective conveyor system 110. Alternatively or in addition, the input devices 230 may be configured to implement dedicated interfaces for the maintenance task. Such interfaces may be specific reader devices arranged in the location of the respective conveyor system 110, for example. The controller 210 may also be communicatively connected to data center 120 as discussed in the foregoing description. Still further, the conveyor system 110 may comprise a number of other entities not explicitly mentioned herein to maintain simplicity in describing aspects in relation to the present invention.

A technician may be assigned a maintenance task to a respective conveyor system 110 which may in accordance with the present example be related to so-called non-critical system of the conveyor system 110. The technician enters a space of the maintenance task and in order to initiate the maintenance of the conveyor system 110 an authorization to perform the maintenance is determined. In accordance with an implementation the person willing to access the conveyor system 110 may provide data indicative of an access right to perform the maintenance to at least one sub-system 225 of the conveyor system 110. The provision of the data may be performed through an input device 230 of the conveyor system 110, for example.

In accordance with an example embodiment the input device 230 may be a reader device arranged to read an identification device assigned to the technician. The identification device may e.g. be at least one of: a tag equipped with RFID technology, a magnetic card, bar code, QR code, a terminal device carried by the technician equipped with identification function suitable to be read with the input device 230, and so on. Such an identification device is referred with a reference 240 in FIG. 2. Alternatively or in addition to a physical identification device 240 the technician may be aware of a code, implemented e.g. as a data string, which is to be input to the input device 230 in the context of authorization. It may also be arranged that in response to an interaction of a physical identification device 240 with the input device 230 a signal requesting a temporary code for accessing the conveyor system 110 may be generated by the input device 230, or the controller 210, receiving data received through the interaction of the identification device 240 and the input device 230. As a result, the controller 210 or the data center 120 (if the controller 210 requests such a code from the data center 120) may be configured to generate a code and transmit it to a terminal device 250 of the technician. For example, the contact details may be possessed by the respective entity, i.e. the data center 120 or the controller 210, together with other related data, if any, such as data related to the maintenance task. In response to the receipt of the code from the respective entity the technician may read it from the terminal device 250 and input it to the input device 230 comprising such a user interface.

Generally speaking, the terminal device 250 may be a wireless communication device configured to communicate at least with one or more entities of the conveyor system 110, such as with the input device 230. The terminal device 250 may be configured to implement an appropriate communication technology, such as any short-range communication technology and/or any wide-range communication technology. Hence, the terminal device 250 may be configured to communicate with a direct link, to utilize a local wireless network, such as Wi-Fi network, and/or to utilize wire area network, such as a mobile communication network. The terminal device 250 may be configured so that it is applied in the maintenance of the conveyor system 110 by connecting it to respective entities therein. Some non-limiting examples of the terminal device 250 may be a mobile phone, a tablet computer, or a laptop computer.

In accordance with any scenario with respect to the authorization the controller 210 may at some point possess data indicative of an access right to perform the maintenance of the conveyor system 110 by means of which it is possible to evaluate if the access right may be authorized i.e. granted to the person represented with the data. The evaluation may be performed by the controller 210 or by the data center 120 if the data is provided there and such an evaluation of the authorization is managed by the data center 120. The evaluation of the authorization may e.g. be performed by the respective entity so that the data is compared to a reference data and if they match in accordance with a predefined rule, it may be detected that the access right to perform the maintenance work may granted.

The entity configured to perform the authorization to perform the maintenance task may also be configured to determine one or more entities i.e. sub-systems 225 of the conveyor system 110 to which the maintenance is to be performed. This piece of information may be stored in data storage accessible by the respective entity or the information may be carried through the interaction with the technician and the conveyor system 110. For example, the piece of information may be associated to the technician under authorization and the information may be obtained from the data storage with one or more identification data indicative of the technician if such data is used in the data structure. Further, aspects in relation to the one or more sub-systems 225 subject to the maintenance may be stored, such as identifier of the sub-systems 225 but also information relating to communication connection to the sub-systems 225 in question. Alternative implementations may also be applied to, such as that a general identifier is defined for the maintenance work under which information e.g. in relation to the technician, the sub-systems 225 as well as maintenance tasks together with any other relevant information is stored to.

In accordance with at least some example embodiments, the entity performing the authorization may be configured to generate a first control causing a disablement of communicatively reaching the sub-system 225 subject to the maintenance. This may refer to an arrangement in which at least an access interface 260 at the sub-system 225, such as a modem, is disabled from any external communication, or any communication. Alternatively or in addition, a communication interface 215 of the conveyor system 110 is disabled so that the sub-system 225 subject to the maintenance is not communicatively available to external sources. This may refer to disabling a network address of the sub-system 225 in question, for example. Alternatively or in addition, the disabled interface may be so-called application programming interface (API) of the respective sub-system 225. Hence, the first control signal may be generated towards an entity configured to manage a communication connection of the sub-system 225 in question and accessing communicatively thereto may be achieved. The first control signal may also be generated in response to a receipt of indication that the maintenance is to be initiated. This may occur e.g. in response to that the technician connects the terminal device 250 to the conveyor system 110 and e.g. generates a signal indicative of the initiation of the maintenance. The receiving entity of such a signal, such as the controller 210 or the data center 120 or both, may then cause a generation of the first control signal.

Moreover, in accordance with another example embodiment the first control signal may be arranged to cause that a service executed by the sub-system 225 is disabled. On the other hand, according to a still further embodiment the first control signal may be arranged to cause a disablement of a sub-system 225 level operation for example so that some part of the sub-system 225 disabled. Such embodiments may be arranged by defining the respective control signal so that it accesses the sub-system and causes the operation as described. As a result, the communicative reach of the respective sub-system 225 may be disabled.

Generally speaking, the embodiment configured to disable the interface 215, 120 so as to disable communicatively reaching the sub-system 225 has an advantage that the maintenance operation may be executed so that the sub-system is still operating for the maintenance. For example, this may help, and accelerate, testing the sub-system in response to the maintenance is performed among other advantages, such as the operation of the conveyor system 110 may be continued, or at least no additional measures need not to be taken such as reconfiguring the system so that its operation may be continued.

Furthermore, at the same time, dependently or independently to each other, another signal may be generated, such as in response to a detection of an access right to perform the maintenance of the sub-system 225 or to the generation of the first control signal, which signal may e.g. unlock the sub-system at least to an extent allowing an access to the sub-system 225 with the terminal device 250 of the technician. Alternatively or in addition, a signal may be generated to the terminal device 250 and information may be provided with respect to the sub-system 225 subject to the maintenance. For example, the information may comprise data, such as an access code, by means of which the technician may access the sub-system 225 in question.

At some point e.g. by applying any of the mechanisms for initiating the maintenance, or at least communicatively connecting the terminal device 250 to the conveyor system, and the sub-system 225, e.g. through an interface enabling access to the sub-system 225. Such an access interface is referred with a reference 260 in FIG. 2. The access interface 260 is not necessarily the interface 215 of the conveyor system 110 which may be disabled to prevent accessing the sub-system 225 from external sources. For sake of completeness it is hereby mentioned that the interfaces 215 and 260 may be the same or different as shown in FIG. 2. In order to perform the maintenance, and the maintenance tasks, the terminal device 250 may be configured to execute an application dedicated to maintenance operations. Such operations may e.g. be setting new configuration to the sub-system 225, such as updating a software version executed by the sub-system 225, setting new operational values for the sub-system 225, uploading or downloading data to and from the sub-system 225 e.g. for back-up purposes, or any similar operation.

At some point the maintenance operation reaches a predefined state, such as it is completed, or it is at any other predefine state. This may be detected by the entity managing the maintenance operation e.g. upon a receipt of an acknowledgement signal from the sub-system 225 under maintenance or from the terminal device 250. Alternatively the detection may be performed on a basis of a predefined setting of time wherein the entity may be configured to maintain a timer for the maintenance. For example, each maintenance operation may be assigned with estimated duration of the maintenance operation and a respective value may be provided to the timer in accordance with the maintenance task. Hence, the predefined state of the maintenance may be defined with the timer value and in response to a run-out of the timer, the predefined state, such as completion of the maintenance, may be detected by the entity managing the maintenance from an internal acknowledgement signal indicative of the run-out of the timer.

In response to the detection of the predefined state of the maintenance e.g. from the acknowledgement signal, the entity managing the maintenance operation may be configured to generate a second control signal to enable the access interface 250 so as to enable reaching of the sub-system 225 communicatively by external entities among others. The external entities may refer to any operator allowed to control the sub-system 225. In other words, the second control signal may cause an activation of the sub-system back to use in the conveyor system 110.

In the foregoing description it is provided a plurality of aspects relating to the present invention. However, the present invention is not only limited to those and in the following further aspects are provided in relation to the present invention.

As discussed, the entity managing the maintenance of the conveyor system 110 in the manner as described may receive data indicative of the access right to perform the maintenance of the sub-system 225 of the conveyor system 110. In accordance with an example implementation of the invention the entity may be arranged to receive, prior to the receipt of data indicative of the access right to perform the maintenance of the sub-system 225 of the conveyor system 110, a request to perform a maintenance of the conveyor system 110. Such a request may trigger a predefined procedure, such as an authorization procedure, by the entity. For example, the entity may be configured to generate a request to provide, or inquire, data indicative of the access right to perform the maintenance. This may refer to prompting the technician to provide necessary pieces of data e.g. though the input device 230. This may be done manually or by using a predefined device or similar.

Moreover, in some examples the entity, such an apparatus implementing a task of the controller 210 or an apparatus of the data center 120, may be configured to determine the sub-system 225 subject to the maintenance from one of: the request to perform a maintenance of the conveyor system; the data indicative of the access right. In other words, the mentioned signals, or pieces of data, may carry information indicative of the sub-system 225, or at least the piece of information may be used for inquiring the information of the sub-system 225 subject to the maintenance from data storage arranged to store such information.

Still further, the entity may be configured to perform the generation of the first control signal to disable communicatively reaching the sub-system 225 so that the generation comprises one of: generating the control signal to the respective communication interface 215; generating the control signal to data center 120 to request disabling of the communication interface 225; generating the control signal to disable a service executed by the sub-system 225; generating the control signal to disable a sub-system level operation. The implementation in which the control signal is generated to the data center 120 may be performed if the entity managing the maintenance is another entity to the data center 120 and the data center is authorized to manage the communication interface 215 e.g. by disabling the communication interface 215. The first control signal may also comprise a piece of data providing at least one definition in relation to the disabling the communication interface 225. For example, the at least one definition may define at least an estimation of a duration of the disabling which may be indicative on an estimated duration of the maintenance, or at least the duration of the disablement.

In case the management of the maintenance occurs locally at a location of the conveyor system 110 e.g. so that the controller 210 is configured to manage the operations, such as the authorization, the entity i.e. the controller 210 may be configured to generate a signal to the data center 120 wherein the signal may comprise data providing at least one definition in relation to the maintenance. For example, it may only indicate to the data center 120 that the maintenance is initiated, or at least requested, with respect to the sub-system 225, but also any other data as discussed. The data center may e.g. set its data records accordingly e.g. for providing information to any entity that the sub-system 225 is under maintenance and the access thereto is prevented.

In the context of any of the examples as discussed in the foregoing description, the entity may also be configured to generate the acknowledgement signal so that it is performed in response to a receipt of data indicative of the access right to perform the maintenance of the sub-system 225 of the conveyor system 110. This may refer to an implementation of the invention so that the technician may indicate that the maintenance is at a predefined state by providing data indicative the access right to perform the maintenance. In other words, the same mechanism, and operation, may be performed e.g. through the input device 230 which was applied in the context of an initiation of the maintenance and in that manner the data may be delivered to the entity for an evaluation of the correctness so as to perform a decision on the generation of the acknowledgement signal.

In accordance with some further example embodiment the entity may further be configured to generate a third control signal to cause an execution of a testing procedure with respect to the sub-system 225 of the conveyor system 110 subject to the maintenance. The aim is to test the sub-system 225 in response to the maintenance operation before it is taken back into use in the conveyor system 110. The third control signal may be an internal signal in the entity which initiates a predefined testing procedure towards the sub-system 225, or towards any other entity, causing the testing procedure towards the sub-system 225. In accordance with some examples, the entity may be configured to generate the third control signal in response to one of the following events: in response to the receipt of the acknowledgement signal indicative of the predefined state of the maintenance; in response to the generation of the second control signal. The first one may refer to an implementation in which the sub-system 225 is tested before the operation of the sub-system 225 is enabled again whereas the latter refers to an implementation in which the operation of the sub-system 225 is enabled and then tested.

A further aspect is that due to a nature of accessibility to perform the maintenance over an applicable communication interface it may occur that the sub-system 225 in question may be accessed from a plurality of locations, such as remotely and locally. However, it may be desirable that the accessing does not occur concurrently in time. Hence, some aspects of the present invention may relate to a mechanism to manage the maintenance task so that prior to granting an access to perform the maintenance task in the manner as described it is determined if there are any pending operations towards the same sub-system 225, or the conveyor system. For example, it may occur that the sub-system 225 is remotely configured in some manner when the technician is accessing the sub-system 225 locally. In this kind of situation, an embodiment of the invention may comprise a procedure in which the technician is prevented to access the sub-system 225 until the prior operation is completed. For example, the entity configured to manage the perform the authorization may receive the information on the pending operation with respect to the sub-system 225 and cause a logging out of the user from the conveyor system 110, or at least inform the technician to wait until the prior operation is completed, or at least it has entered to a predefined stage and access to another maintenance task may be granted.

As mentioned herein the entity managing the maintenance in the manner as described may be an entity of the conveyor system 110 or it may be an entity belonging conceptually to the data center 120. The entity may refer to an apparatus configured to perform the management of the maintenance, or a plurality of apparatuses to perform the same. The application of the plurality of apparatuses may be implemented so that a first number of apparatuses reside conceptually in the conveyor system 110 and a second number of apparatuses reside in the data center 120, for example. Hence, the invention is possible to establish in a distributed computing environment, such as by applying cloud computing for the task.

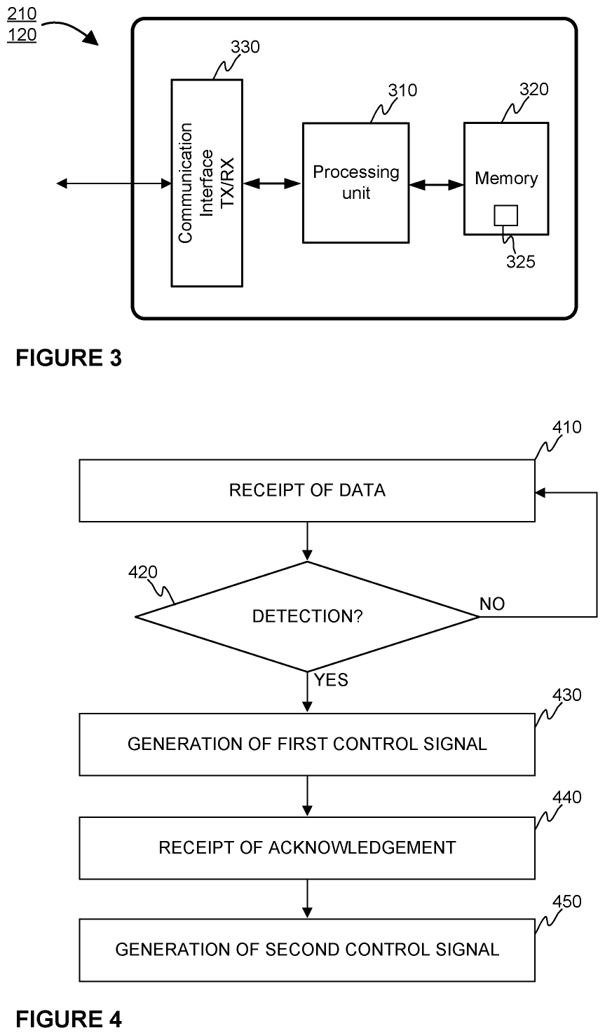

An example of an apparatus configurable to implement the present invention is schematically illustrated in FIG. 3. The apparatus of FIG. 3 may e.g. be configured to perform a function of the controller 210 as described or a computing device of the data center 120 so as to manage the maintenance. For sake of clarity, it is worthwhile to mention that the block diagram of FIG. 3 depicts some components of an entity that may be employed to implement a functionality of the apparatus 210, 120. The apparatus 210, 120 comprises a processor 310 and a memory 320. The memory 320 may store data, such pieces of data as described but also computer program code 325 causing the management of the maintenance in the described manner. The apparatus 210, 120 may further comprise a communication interface, such as a wireless communication interface or a communication interface for wired communication, or both. The communication interface may thus comprise one or more modems, antennas, and any other hardware and software for enabling an execution of the communication e.g. under control of the processor 310. The communication interface 330 may also comprise a portion implementing the communication interface towards the sub-system 225 in question which portion may be controlled in the described manner in at least some embodiments of the invention. Furthermore, I/O (input/output) components may be arranged, together with the processor 310 and a portion of the computer program code 325, to provide a user interface for receiving input from a user, such as from a technician, and/or providing output to the user of the apparatus when necessary. In particular, the user I/O components may include user input means, such as one or more keys or buttons, a keyboard, a touchscreen, or a touchpad, etc. The user I/O components may include out-put means, such as a loudspeaker, a display or a touchscreen. The components of the apparatus may be communicatively connected to each other via data bus that enables transfer of data and control information between the components.

The memory 320 and a portion of the computer program code 325 stored therein may further be arranged, with the processor 310, to cause the apparatus 210, 120 to perform at least a portion of a method for managing the maintenance as is described herein. The processor 310 may be configured to read from and write to the memory 320. Although the processor 310 is depicted as a respective single component, it may be implemented as respective one or more separate processing components. Similarly, although the memory 320 is depicted as a respective single component, it may be implemented as respective one or more separate components, some or all of which may be integrated/removable and/or may provide permanent/semi-permanent/dynamic/cached storage.

The computer program code 325 may comprise computer-executable instructions that implement functions that correspond to steps implemented in the management of the maintenance when loaded into the processor 310 of the controller 185. As an example, the computer program code 325 may include a computer program consisting of one or more sequences of one or more instructions. The processor 310 is able to load and execute the computer program by reading the one or more sequences of one or more instructions included therein from the memory 320. The one or more sequences of one or more instructions may be configured to, when executed by the processor 310, cause the apparatus to perform a method as explicitly described in the forthcoming description. Hence, the apparatus 210, 120 may comprise at least one processor 310 and at least one memory 320 including the computer program code 325 for one or more programs, the at least one memory 320 and the computer program code 325 configured to, with the at least one processor 310, cause the apparatus to perform the method.

The computer program code 325 may be provided e.g. a computer program product comprising at least one computer-readable non-transitory medium having the computer program code 325 stored thereon, which computer program code 325, when executed by the processor 310 causes the apparatus 210, 120 to perform the method. The computer-readable non-transitory medium may comprise a memory device or a record medium such as a CD-ROM, a DVD, a Blu-ray disc, or another article of manufacture that tangibly embodies the computer program. As another example, the computer program may be provided as a signal configured to reliably transfer the computer program.

Still further, the computer program code 325 may comprise a proprietary application, such as computer program code for causing an execution of the method in the manner as described in the description herein.

Any of the programmed functions mentioned may also be performed in firm-ware or hardware adapted to or programmed to perform the necessary tasks.

As already mentioned, the entity performing the method may also be implemented with a plurality of apparatuses, such as the one schematically illustrated in FIG. 3, as a distributed computing environment. For example, one of the apparatuses may be communicatively connected with other apparatuses, and e.g. share the data of the method, to cause another apparatus to perform at least one portion of the method. As a result, the method performed in the distributed computing environment generates the detection result as described.

For sake of completeness, even if at least some aspects of the management of the maintenance are described in the foregoing description a method in accordance with an example is explicitly disclosed in the forthcoming description by referring to FIG. 4. In other words, FIG. 4 illustrates schematically a method according to an example for managing the maintenance of the conveyor system 110, and specifically the sub-system 250 therein. The method according to the example embodiment is described from the apparatus 210, 120 point of view. First, the apparatus 210, 120 may receive 410 data indicative of an access right to perform a maintenance of a sub-system 250 of the conveyor system 110. The apparatus 210, 120 is configured to perform a detection 420, based on the received data, if the requested may be provided an access right to perform maintenance to the conveyor system 110, and the sub-system 250 therein. The detection step 420 may generate a result indicating that no access right may be granted (the branch denoted with “NO” in FIG. 4) and the apparatus 210, 120 may be returned to receive data, or at least to way for another access attempt. Alternatively, the apparatus 210, 120 may be configured to detect 420, through an evaluation process, that the access right may be granted (the branch denoted with “YES” in FIG. 4). In response to the detection of an access right to perform the maintenance of the sub-system a first control signal may be generated 430 to disable communicatively reaching the sub-system 225. The disabling may be performed in any of the manner as described in the foregoing description. During the time window the interface is disabled the sub-system 225 in question may be maintained in a manner and at some point, the apparatus 210, 120 receives 440 an acknowledgement signal which is indicative of a predetermined state of the maintenance, such as the maintenance work is completed. In response to the receipt of an acknowledgement signal 440 a second control signal is generated 450 which causes an enablement of the interface to communicatively reach the sub-system 225 through the respective interface.

The method in accordance with the present invention may comprise further steps as described in the foregoing description relating to other figures. Moreover, the described steps of FIG. 4 may comprise sub-steps for implementing the step as described.

The invention as described with the help of examples is mainly related to a maintenance of a non-safety-critical sub-system in the conveyor systems 110. However, the invention may also be applied with the safety critical sub-systems in case the maintenance task itself does not risk the operation of such a sub-system, but for safety reasons any external communication is prevented with the solution.

The specific examples provided in the description given above should not be construed as limiting the applicability and/or the interpretation of the appended claims. Lists and groups of examples provided in the description given above are not exhaustive unless otherwise explicitly stated.

1. An apparatus for managing a maintenance of a conveyor system, the apparatus configured to:
receive data indicative of an access right to perform the maintenance of a sub-system of the conveyor system,
generate, in response to a detection of an access right to perform the maintenance of the sub-system, a first control signal to disable communicatively reaching the sub-system,
generate, in response to a receipt of an acknowledgement signal indicative of a predefined state of the maintenance, a second control signal to enable communicatively reaching the sub-system.

2. The apparatus of claim 1, the apparatus further configured to:
receive, prior to the receipt of data indicative of the access right to perform the maintenance of the sub-system of the conveyor system, a request to perform a maintenance of the conveyor system.

3. The apparatus of claim 2, wherein the apparatus is configured to generate a request to provide data indicative of the access right to perform the maintenance.

4. The apparatus of claim 1, wherein the apparatus is configured to determine the sub-system subject to the maintenance from one of: the request to perform a maintenance of the conveyor system; the data indicative of the access right.

5. The apparatus of claim 1, wherein the apparatus is configured to determine the maintenance task of the sub-system from one of: the request to perform a maintenance of the conveyor system; the data indicative of the access right.

6. The apparatus of claim 1, wherein the apparatus is configured to generate the first control signal to disable communicatively reaching the sub-system by one of: generating the control signal to a respective interface to disable the respective interface; generating the control signal to data center to request disabling of the interface; generating the control signal to disable a service executed by the sub-system; generating the control signal to disable a sub-system level operation.

7. The apparatus of claim 1, wherein the first control signal comprises data providing at least one definition in relation to the disabling communicatively reaching the sub-system.

8. The apparatus of claim 7, wherein the at least one definition defines at least an estimation of a duration of the disabling.

9. The apparatus of claim 1, the apparatus further configured to generate a signal to data center, the signal comprising data providing at least one definition in relation to the maintenance.

10. The apparatus of claim 1, wherein the apparatus is configured to generate the acknowledgement signal in response to a receipt of data indicative of an access right to perform the maintenance of the sub-system of the conveyor system.

11. The apparatus of claim 1, the apparatus further configured to generate a third control signal to cause an execution of a testing procedure with respect to the sub-system of the conveyor system subject to the maintenance.

12. A method for managing a maintenance of a conveyor system, the method, performed by an apparatus, comprises:
receiving data indicative of an access right to perform the maintenance of a sub-system of the conveyor system,
generating, in response to a detection of an access right to perform the maintenance of the sub-system, a first control signal to disable communicatively reaching the sub-system,
generating, in response to a receipt of an acknowledgement signal indicative of a predefined state of the maintenance, a second control signal to enable communicatively reaching the sub-system.

13. The method of claim 12, the method further comprises:
receiving, prior to the receipt of data indicative of the access right to perform the maintenance of the sub-system of the conveyor system, a re-quest to perform a maintenance of the conveyor system.

14. The method of claim 13, wherein a request to provide data indicative of the access right to perform the maintenance is generated.

15. The method of claim 12, wherein the sub-system subject to the maintenance is determined from one of: the request to perform a maintenance of the conveyor system; the data indicative of the access right.

16. The method of claim 12, wherein the maintenance task of the sub-system is determined from one of: the request to perform a maintenance of the conveyor system; the data indicative of the access right.

17. The method of claim 12, wherein the first control signal to disable communicatively reaching the sub-system is generated by one of: generating the control signal to a respective interface to disable the respective interface; generating the control signal to data center to request disabling of the interface; generating the control signal to disable a service executed by the sub-system; generating the control signal to disable a sub-system level operation.

18. The method of claim 12, wherein the first control signal comprises data providing at least one definition in relation to the disabling communicatively reaching the sub-system.

19. The method of claim 18, wherein the at least one definition defines at least an estimation of a duration of the disabling.

20. The method of claim 12, the method further comprises:
generating a signal to data center, the signal comprising data providing at least one definition in relation to the maintenance.

21. The method of claim 12, wherein the acknowledgement signal is generated in response to a receipt of data indicative of an access right to perform the maintenance of the sub-system of the conveyor system.

22. The method of claim 12, the method further comprises:
generating a third control signal to cause an execution of a testing procedure with respect to the sub-system of the conveyor system subject to the maintenance.

23. A computer program comprising computer readable program code configured to cause performing of the method according to claim 12 when said program code is run on one or more computing apparatuses.

24. A conveyor system comprising the apparatus according to claim 1.
